(19) United States
(12) Patent Application Publication
(10) Pub. No.: US 2017/0269340 A1
(43) Pub. Date: Sep. 21, 2017

(54) COLLAPSIBLE IMAGING SYSTEM HAVING LENSLET ARRAYS FOR ABERRATION CORRECTION

(71) Applicant: ALMALENCE INC., Austin, TX (US)

(72) Inventor: Dmitry Valerievich SHMUNK, Novosibirsk (RU)

(21) Appl. No.: 15/617,500

(22) Filed: Jun. 8, 2017

Related U.S. Application Data
(63) Continuation-in-part of application No. 15/048,008, filed on Feb. 19, 2016, now abandoned.

(51) Int. Cl. G02B 13/00; G02B 3/00; G02B 9/12; G02B 27/00; H04N 5/225; G02B 7/02; H04N 5/232

(52) U.S. Cl. CPC G02B 13/0055; G02B 7/023; G02B 3/0056; H04N 5/23229; G02B 27/0025; H04N 5/2251; H04N 5/2253; H04N 5/2254; G02B 9/12

(57) ABSTRACT

A collapsible imaging system having a compound lens and a lenslet array, which is coupled with an image sensor. The collapsible imaging system can be transitioned between the imaging and storage modes by moving compound lens elements along the optical axis and off the optical axis of the system. In the storage mode, the compound lens elements are tightly packed in a flat volume.

### CROSS REFERENCE TO RELATED APPLICATIONS

This application is a continuation-in-part of U.S. application Ser. No. 15/048,008, filed on Feb. 19, 2016; the entire content of which is hereby incorporated by reference.

### FIELD OF INVENTION

The invention relates to compact optical systems, specifically to a collapsible optical assembly combined with a lens array and a digital filter to improve image quality.

### BACKGROUND OF THE INVENTION

Optical lenses designed for imaging are, typically, formed of a plurality of matching optical components in a system known as a ‘compound lens’. Multiple components are required for the optical system to cope with imaging errors and distortions to achieve high image resolution.

The high quality lens systems marketed by leading DSLR (digital single-lens reflex) camera manufacturers such as Canon and Nikon are often comprised of seven or more discrete lens elements to form a high-performance compound lens. While such complex compound lenses provide exceptionally high image quality, they tend to be bulky due to its substantial weight and size. A typical DSLR lens used for professional photography can weigh more than several pounds and have a size of several tens of centimeters.

While the burden of such bulky lenses is acceptable in some cases, many photographers consider it too inconvenient for casual use. There is a constant market demand for much lighter and smaller systems capable of high quality imaging. Accordingly, a great effort has been made to achieve lightweight compound lens systems that still have good imaging characteristics.

The most preferred approach adopted by camera manufacturers involves a collapsible compound lens that has two operational modes, namely, a storage mode and an imaging mode. Such collapsible lens system can be compressed along a system optical axis, thus reducing the space between lens elements in a telescopic action, essentially, transitioning from the imaging mode to the storage mode.

In reverse, the extension from the collapsed state brings lens elements to their precise imaging (working) position using a precisely designed mechanical system. Such telescopic lens systems are widely used in many types of cameras and video devices.

While telescopic collapsible compound lens systems offer a significant weight and size reduction along with excellent image quality, they still have many drawbacks that limit their wide adoption for modern compact imaging devices.

For example, mobile telephone systems use a fixed lens rather than a collapsible one. Similarly, video devices for sport activities, such as GoPro cameras, also configured with a fixed lens having a single opto-mechanical operational mode with no compact storage option.

In the case of mobile devices and smartphones, space (and thickness in particular) is a high priority. Accordingly, lens systems used in smartphone cameras must provide a wide field of view and, at the same time, be very thin (flat) to satisfy integration and packaging requirements of the consumer.

Such design constrains generally impose limitations on imaging. Indeed, since so many people enjoy using their portable devices for photography, an entire industry was developed around a lens extensions of smartphone cameras. For example, telephoto extenders, macro-lens systems and other accessories have been offered in a clip-on format to be used for compact (e.g. smartphones) imaging. Such accessories provide two modes of operation, with the storage mode that requires a physical removal of the lens extension device. Obviously, using of such removable additional lens systems is often inconvenient and unpractical in real-life situations.

Implementations of lens arrays in conjunction with image sensors are well-described elsewhere (see, for example, Brady et. al.,“Multiscale Lens Design”, Optical Society of America, Vol. 17, Issue 13, pp. 10659-10674 2009). In this paper, a general multi-scale optic concept is outlined where the optical imaging system has two parts: a ‘collector’—a first stage with the arranged compound lens and a ‘processor’—a second stage that is comprised of a lens array in a close proximity to an image sensor. The array is composed of lenslets that are specifically tuned and fashioned to modify the propagated light to improve the image quality. The means for aberrations correction at the collector stage using the image processor are also disclosed in this paper.

The aforementioned method assumed that the position of the lenslet within the array can be controlled with a great precision. However, such precise array manufacturing, positioning and calibration is possible for certain high-end optical systems only (e.g. microscopes, telescopes, cameras, video imagers) where the primary compound lens is fixed and stationary, versus being movable and/or collapsible.

A typical compound lens of a collapsible system, (e.g. a telescopic barrel lens) usually has some inevitable deviations from the perfect lens positioning. Such deviations introduce an additional form of aberration which is different from the aberrations commonly introduced by errors in lens geometry and are caused mostly by slightly off-axis mounting of the compound lens (system) when it moves into its working position from the storage in collapsible system.

The current disclosure suggests using the lens arrays to correct the mentioned lens placement aberrations for collapsible systems. As it is discussed in details below, the collapsible systems generate certain types of imaging error due to the lens placement variance, and those errors (aberrations) may be corrected by the proposed lenslet design. For this purpose, the wavefront effects (or ray bundles behavior in the geometrical optics) near the image detector have to be measured and/or calculated.

The optical collapsible systems have already been presented elsewhere in application Ser. No. 14/860,739 where a compact thin (flat) configuration of compound lens elements was described for the storage and operating modes. In the storage mode, lens elements are held in a very thin flat space, enabling an efficient integration with compact devices, such as smartphones and tablets. However, the described configuration is still prone to aforementioned imaging aberrations and requires new aberration correction methods.

Nowadays, lens arrays can be formed with a great manufacturing control over the nature of the lenslet elements. Thus, both refractive and diffractive lens types can be readily formed in variety of shapes. For example, Suss MicroOptics have been providing microlens arrays for special applications by for more than 25 years.

All existing lenslet array applications, however, have certain limitations that prevent a widespread use of the technology for compact (e.g. collapsible) systems. While smartphone maufacturers manage to provide good quality imaging systems in very small packages, they are nevertheless limited due to the very small lens sizes resulted from the package space constraints. It is very inconvenient for smartphone designers to deploy barrel type telescopic collapsing lens system, such as those found in common point-and-shoot portable cameras. Instead, smartphones tend to use instead a fixed lens arrangement.

Since users of smartphone/portable cameras constantly pursue high quality imaging (and lens choice availability), a secondary market for extension devices have been thriving. Thus, the compound lenses clipped to the external housing of smartphones are widely available on phone accessories market. In further response to user demand for better imaging optics, manufacturers constantly seek additional ways to improve the imaging optics of very small cameras without over packing the available space. While collapsible telescopic compound lenses are suitable for certain mini camera systems, even the best of them tend to remain prohibitively thick and, as a result, unsuitable for use in space constrained applications.

One possible existing solution is described in WO/2016/053140 where a collapsible lens that can be transitioned between the imaging and storage modes where the storage mode is characterized by having elements of the compound lens collapsible into a conventional planar volume of very thin dimension (up to a few millimeters). Even for such collapsible systems, however, the accurate mechanical interlocking deteriorates with time, i.e. after multiple transitions between image and storage operational modes.

The overall thickness of most modern smartphones is about 10 millimeters, which restricts the dimension of respective lens and detector combination integrated into the housing. Other imaging systems often require small and light imaging systems. For example, new drone-based flying cameras benefit from lightweight payloads that substantially extend the flying time.

It was discovered that certain corrections could ‘unmap’ the induced image aberrations in the digital domain. Thus, with a knowledge of a particular optical system, a digital filter can be predesigned in order to compensate for the specific aberrations caused by the (anticipated) lens placement errors. Such technology is described in details in the patent application to Shmunk, application Ser. No. 15/366,797.

The present invention describes collapsible lens systems having lens array elements deployed for aberration correction. The primary function of such optical imaging systems is to provide a very high image quality regardless of mechanical imperfections that are inevitably present in collapsing arrangements. The main distinctive features of the invention from the prior art is an ability to collapse along the off-axis directions, employing off-axis collapsing elements.

It is another primary object of this disclosure to provide novel lightweight, extremely compact (i.e. collapsible) optical imaging systems for high-quality imaging (e.g. low aberrations and high resolution). The current disclosure suggests using the micro-lens arrays to correct the lens placement aberrations that appear in collapsible compact (e.g. thin) optical imaging system.

The main technological advantage of the proposed device and method is mitigation of aberrations caused by the lenslet arrays misalignments. Specifically, the proposed lens array elements are designed to operate on incident optical wavefronts in order to reduce the image errors resulted from known mechanical variances associated with an optical receiver design.

### SUMMARY OF THE INVENTION

The invention describes a collapsible imaging system that consists of a compound lens (such as, for example, a Cooke triplet) and a lenslet array coupled with an image sensor. The system can be transitioned between the imaging and storage modes by moving compound lens elements along the optical axis and off the optical axis of the system. In the storage mode, the compound lens elements are tightly packed in a flat volume.

The diffractive, refractive characteristics, shape and focusing power of the lenslets can vary, also depending on the location within the lenslet array. The surface area of each lenslets can be about 0.5-5 square millimeters, while their aperture can be less than one 1 square millimeter.

The lenslet array and image sensor can include a multiple number of smaller lenslet arrays and smaller image sensors, respectively. For such configuration, the lenslets have a focusing power specifically distributed to steer the incident light away of the boundaries between the smaller image sensors.

The system can include a digital filter to further compensate for specific aberrations caused by the disclosed imaging system. Such filter can be based on the artificial neural network.

### BRIEF DESCRIPTION OF THE DRAWINGS

FIG. 1: An Optical ray tracing diagram showing a simplified compound lens suitable for imaging.

FIG. 2: Array tracing diagram including a specific optical element near the image plane.

FIG. 3: A prior art diagram showing a clip-on lens extension suitable for high performance imaging in conjunction with a mobile phone.

FIG. 4: A mechanical system of optical elements designed to receive and hold lens elements and transition them between imaging and storage modes.

FIG. 5: An alternative version of the mechanical system of optical elements having a pivoting mechanism to flip the elements between storage to imaging modes.

FIG. 6: An example of a very thin collapsible lens system being integrated into a mobile smartphone.

FIG. 7: A ray tracing diagram that illustrates the imaging process by focusing via a lens array.

FIG. 8: A perspective ray tracing diagram that illustrates the imaging process by focusing via a lens array.

FIG. 9: An example of lenslet arrays where each lenslet has a polygon shape (with generally arbitrary surface shape and arbitrary shape of edges) and variable focusing power.

FIG. 10: An example of compound image sensor made of four single sensor packages.

FIG. 11: A configuration of adjacent lenslets to steer the optical rays from the ‘dead zones’ located along the boundaries of the adjacent image sensing elements.

### DETAILED DESCRIPTION OF THE PREFERRED EMBODIMENT

Throughout this disclosure, reference is made to some terms which may or may not be exactly defined in popular dictionaries as they are defined here. To provide a more precise disclosure, the following term definitions are presented to clarify the embodiment of invention. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning.

For purposes of this disclosure, a ‘lenslet’ is defined as a microlens, being an element of a lenslet arrays or micro lens array. Such lenslet arrays have been used in a variety of compound optical elements and systems due to their unique opto-mechanical characteristics, such as advanced microlithography-based manufacturing technology. Furthermore, spatial variance of lenslet within an array can be designed and controlled, hence providing different optical characteristics at different areas of the array.

For purposes of this disclosure a ‘lens array’ and/or a ‘microlens arrays’ are optical systems having a two-dimensional distribution of discrete lens elements over a surface of a substrate. Both refractive and diffractive microlens lens arrays can be formed (e.g. carved out, glued, spattered, etc.) at the a surface of optical material with predesigned optical power distribution with regard to incident wavefronts.

For purposes of this disclosure, a ‘substrate’ or ‘frame’ element is a mechanical structure provided to receive and hold therein an optical lens. The substrate or frame having a mechanical relationship with cooperating coupled frames whereby they operate together to switch between an imaging mode and a storage mode.

The current disclosure describes the alternative aberration correction method of the image taken by disclosed collapsible systems, where the image correction means are specifically adjusted to compensate for imperfect mechanical lens alignment or placement errors of the optical system. The disclosed opto-mechanical systems have collapsible compound lens located either in imaging mode or in a storage mode, while the storage mode enables very thin configuration of the compound lens optical system.

Specifically, for the preferred embodiment of the invention, a lens array is located in a close proximity to the image detector. The lens array is comprised of a plurality of lenslet elements distributed over a surface area substantially normal with respect to the system optical axis. These lens arrays have lenslet elements which may have either a refractive or diffractive effect on the incident wave-fronts. Such lens arrays are substantially different in comparison to similar lens array devices used previously in other imaging system due to their different wave-front transformation. Thus, the wave-front transformation is specifically designed to counteract imaging effects related to the lens placement variations and the resulting specific aberrations.

The disclosed collapsible systems generate certain types of imaging errors (to the captured image) that caused by the lens placement variance. These errors (i.e. aberrations due to imperfect lens alignment) can be characterized, measured and subsequently corrected by the disclosed lenslet design.

Taking into account the pre-determined aberrations, which are generally caused by a mechanical collapsing lens mount, the lenslet design is substantially different from the previous art related to the image lens arrays.

For example, in the prior art, the lens arrays were used for improving the light concentration towards the discrete detecting bins, away from the detecting “dead zones” (increasing so-called “fill factor” of the detector). While such arrangements can be useful, they have never been applied to compensate aberration caused by the lens misalignment in collapsible systems.

An innovative optical system proposed and presented here to facilitate collapsing or folding a camera lens module into a thin planar space, while providing state-of-the-art image resolution.

For the purpose of the disclosed invention, a so-called multi-scale optics design may be employed, where the optical system is constructed from two parts, including: a ‘collector’ lens group, and a layer of lenslets, (the lenslet arrays or micro lens arrays). This collector group of lenses defines general nature of imaging and sets the optical system parameters like an aperture F# and a focal length. While typical high imaging systems having compound lenses made of about 5-15 elements, for the preferred embodiment of the invention, the lightweight and space conserving collector is proposed. For example, a Cooke triplet arrangement of three lens singlets can form the basis of the collector for the preferred embodiment of the invention.

Other options may include a doublet system to be used as a collector with arrangement of two discrete integrated lenses paced in contact or close proximity. Such systems may be mounted in a single mechanical frame. Because the nature of a doublet prescribes that there be little or no space between the two elements, there is no or little advantage in collapsing the doublet. Therefore, some arrangements of these collapsible lens mounts have two lenses of a doublet affixed within a single frame element. Thus, compound lenses which are most suitable for the preferred embodiment of the collapsible have about 3-5 lens elements.

While such simplified compound lenses can, technically, produce more aberrations than their more sophisticated alternatives (with a greater number of lens elements), they do, nevertheless, offer far greater potential for applications with folding and/or collapsible physical mechanisms used to transition between an imaging mode and storage mode. Indeed, where a compound lens has too many lens elements, the mechanism which could achieve a desirable collapsing action tends to be overly complex and prohibitively difficult to manufacture. Too many substrate elements of a folding mechanism impair the ability to operate in a smooth and efficient manner. Furthermore, for the compound lenses of multiple discrete components, the lens positions and orientations of each component must be maintained with a very high precision, essentially, precluding such arrangements from being used in foldable and collapsible camera modules described herein.

The aberrations can result from mechanical misalignments that especially pronounced in high performance compound lenses with multiple elements. In the proposed schemes, however, the collector lenses are simplified to include fewer elements and high precision positioning (which is virtually impossible with folding mechanics) is not required. The primary function of the second part or the lens array portion of the optical system is to compensate for optical aberrations that are inevitably created within the simplistic collector part.

A described lens array when carefully used in conjunction with image detectors improves the fill-factor by reducing the inactive portion of a detector surface (the “dead zone”). Such use of lens arrays is well-known by experts in digital imaging. However, the use lens arrays in combination with the collector portion of a compound lens to mitigate aberrations have not been disclosed so far.

Since the compound lens can be well defined in advance, its respective aberrations can be reduced by application of correction with radial distribution.

The unique feature of the lens array, is that the individual small lenses distributed over a surface area, can each have a focusing power independent of its neighbor. This feature can be used in connection with the expected imaging error produced by the simplified compound lens, such as, for example, a Cooke triplet.

In the prior art, the lens arrays with a pixelized detector is merely used to collect light and direct the light to a prescribed bin or light sensitive area. The focus power of each lens is typically identical for all lens array elements regardless their distance from the system optical axis.

In the current disclosure, however, since the aberrations produced by any particular collector portion of these systems are well known in advance, a lens array can be fine-tuned to operate on the wave front just prior to the imaging plane to ‘undo’ some aberrations caused by the collector.

The thin lens array in combination with the imaging detector is further suitable for use with folding and collapsing systems described. Such novel use of lens arrays at the proximity if the collapsible lens system imaging plane can produce a very high performance system with additional advantages in terms of light weight and small size. Furthermore, thin lens array in combination with the imaging detect are well suited for collapsible systems that transition compound lens components between the described imaging and storage modes.

Such disclosed collapsible systems include a lens array and imaging detector combination that can be mounted in a single mechanical frame of the optical system. The lens array and imaging detector (sensor) could be rigidly affixed (e.g. fastened or affixed with adhesives) to each other to form a single (preferably thin) element of the collapsible system. The collapsible system can be adopted to accommodate such combination of image detector and lens array.

The preferred embodiment of the invention includes sliding or folding means provided for the collector lens elements from which a compound lens may be formed. However, it is possible to arrange elements into subgroups whereby more than one lens or other component of optical system (i.e. filter, lens array, corrector plate, etc.) can be included into the folding/sliding element of the system systems and these subgroups of elements are moved together as a single unit.

In the preferred embodiment of the invention, lenslets are organized into a hexagonal (“honeycomb”) array to maximize the effective aperture, or area affecting the imaging wave-front rays from which the useful image is formed. While similar hexagonal configuration have been used before (e.g. to improve the fill-factor), such systems haven't been designed specifically to match lenslet array pattern and detector's dot pitch. (Dot pitch is a specification for a pixel-based device that describes the distance between dots, e.g. pixels or sub-pixels).

In the disclosed invention, the purpose of the lens arrays is not to improve the fill-factor, but rather to reduce aberrations, providing more options for the lenslet arrays geometry and design.

In some embodiments, the lenslets may be quite large with respect to the detector pixel elements. Because the lenslet is designed to modify the wave-front with respect to image aberrations, its physical nature dependent upon the optical design of the collector, rather than the structure present in the detector device. In some optimal versions, each lenslet has a ‘free-form’ refracting surface, possibly being not symmetric relatively to the optical axis. In other words, generally, the refracting surface of each lenslet may be asymmetrical. In one possible embodiment of the invention, only a single lenslet surface is curved, while other lenslet surface is flat. These kind of lens arrays could simplify manufacturing of the device, while, nevertheless, provide the desirable aberration corrections.

It is also possible to use lens arrays where both surfaces are free-form. In this case, there are even more degrees of freedom in the lenslet shape, which allows correcting aberrations even better.

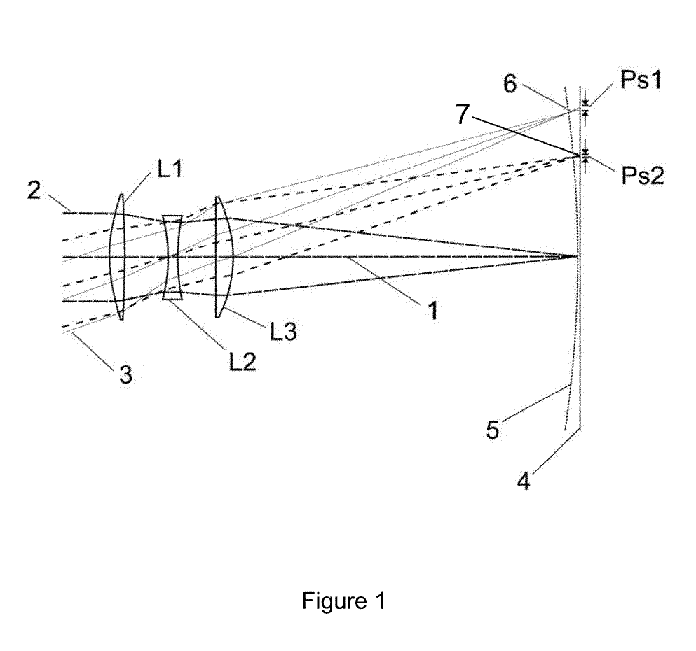

FIG. 1 illustrates a widely known version of a compound lens, commonly called a ‘Cooke triplet’, where the three singlet lens elements operate in conjunction with each other to focus optical rays into the image field. While the Cooke triplet is important for its ability to correct all seven Seidel aberrations, it is, nevertheless, still imperfect since certain aberrations are not fully mitigated. To achieve a higher imaging system performance, lens designers rely upon more complex compound lens systems or use of the Cooke triplet in conjunction with other supporting error correction schemes.

Similarly, in the present inventions, the Cooke triplet-based compound lens operates in combination with other corrective means. The ray trace diagram of FIG. 1 illustrates a triplet designed to focus three wave-fronts into the image field. An optical axis 1 (imaging axis) defines the axial symmetry of the optical system. As shown, lens elements L1, L2 and L3 are arranged along the axis 1 to receive far-field rays or the wave-fronts. In connection to FIG. 1, the incident wave-front 2 is parallel to the axis, while the wave-front 3 incident at the angle with respect to the axis 1. Under the ideal imaging geometry, all wave-fronts would be focused into a planar image field 4. However, due to the imaging imperfections of the compound lens system, the true nature of the image field appeared to be slightly spherical, and the best focusing (e.g. the smallest spot size) for all incident wave-fronts is belong to the curved surface 5.

Accordingly, when an imperfect lens is used with a planar image detector, some defocusing (i.e. spreading of the focus point) is observed. In simplest models, the further focus point moves from the optic axis, the larger such spreading of the focus point would be. Thus, the point spreading at photodetector PS1 is larger than the point spreading at PS2 (shown in the FIGS. 1 as 6 and 7, respectively).

The point spread-function depends on (radial) distance from the system axis. Thus, for the best focusing, the planar image wave-front should be moved slightly towards the lens in order to minimize the spreading point both in the center and at the periphery of the image.

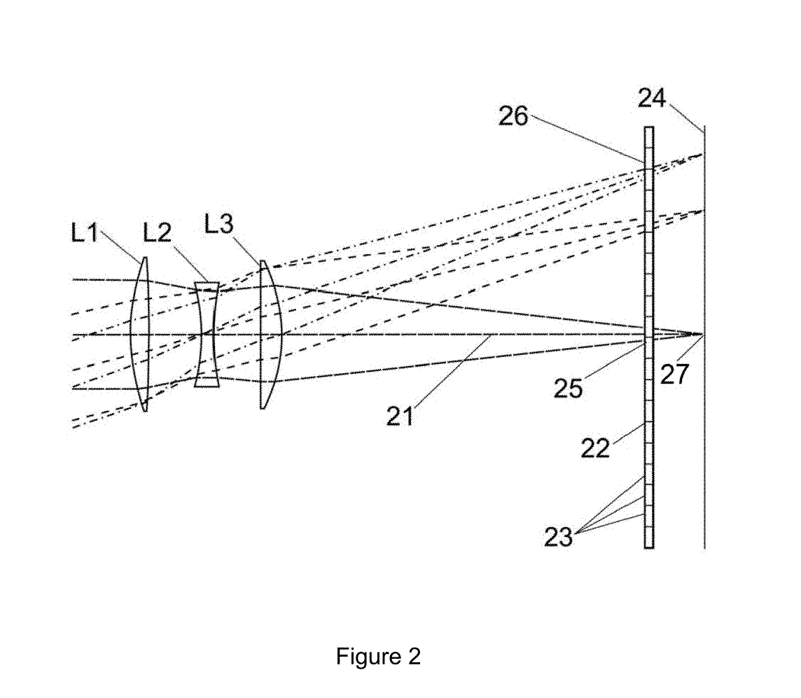

FIG. 2 further illustrates a preferred embodiment of the compound (e.g. Cooke triplet) imaging system with lens aberrations. With the reference to the FIG. 2, the three lens elements L1, L2 and L3 are placed along the system optical axis 21. A special optical element 22 is located in proximity of the image field plane 24, in a form of the array of lens elements distributed over a surface in two dimensions.

Such lens array 22 is comprised of a many individual lens elements 23 and can be realized on a thin substrate of the optical material. In the preferred embodiment of the invention, the lens array 22 is placed at the distance from 0.5 millimeters for up to several millimeters from the image field plane 24, where optical rays come to a sharp focus.

Each of the individual lenses 23 can have its own focus power or strength. Accordingly, it is possible to define (e.g. pre-calculate or design) a radial function that describes the parameters (e.g. optical power/strength) of the lenses 23 within the array 22 as a function of the distance from the optical axis 21. Specifically, in the preferred embodiment of the invention, such function is designed to compensate for the compound lens aberrations. Specifically, the lenses 23 of the lens array 22 that are near the center (axis) have a stronger focus, causing the focus point 27 to be moved toward the left in the FIG. 2 (enabling a shorter focus distance). The lenses at the periphery of the image field 26 have a smaller (or negligible) focus power to affect the focus location 27. In this way, a lens array, as a whole optical element, can be used to ‘flatten’ the focus field from a curved (aberrated) surface into a flat plane 24, providing a higher quality (i.e. focus, resolution) for the all image field.

For the preferred embodiment of invention, it is desirable to avoid negative focus power on individual lenses 23 of a lens array 22. Accordingly, a configuration is preferred whereby the lens array 22 operates most strongly on the rays near the axis 21 of the optical system and with gradually decreasing power of lenses 23, when the (radial) distance from the axis 21 increases. While an opposite effect (e.g. function with negative focus power distribution, lengthening the focus in the FIG. 2 by moving the focus point 27 to the right (extending the focus)) is possible, it remains less practical for the preferable embodiment of the invention.

Since the conventional optical lenses are bulky and cannot be integrated into a mobile smart phone package, the after-market manufacturers have designed extension lenses to be coupled into smartphone cameras via ‘clip-on’ means.

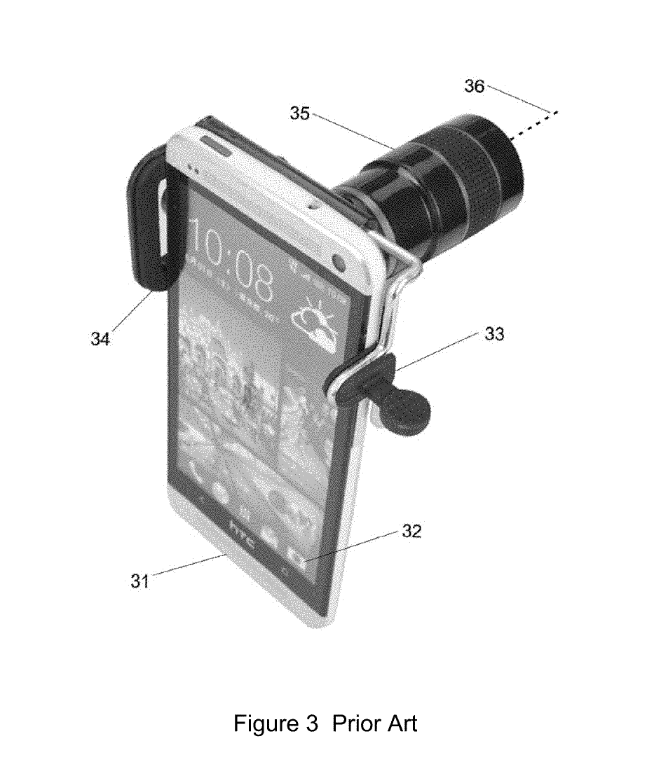

FIG. 3 shows a typical lens accessory that has been used in combination with a smartphone. A smartphone 31 includes an interface 32 that drives a camera function. Camera software, imager, and built-in lens are all contained within a very thin package or smartphone housing. A special mounting hardware 33 and cooperating clip 34 enable the coupling of barrel lens 35 having optic axis 36. Users may add such device prior to making photographs or videos by removing the lens from a storage case and affixing it to the smartphone exterior. When finished with using the camera, the user removes the lens and replaces it into storage. While useful, these lenses nevertheless have significant obvious drawbacks, such as bulky size and complicated usage, essentially undermining the concept of the portable device. For example, such barrel lens accessories are disclosed in U.S. Pat. Nos. 7,453,513, 8,477,230 and 9,182,568, however, they nevertheless remain too bulky for use on thin and compact devices such as a mobile smartphone.

Another prior art alternative solution (for example, the U.S. Pat. No. 5,636,062 to Okuyama et al. and U.S. Pat. No. 5,715,482 to Wakabayashi et al.) is based on a barrel lens that capable to collapse along its axis to utilize (remove) the space between the individual elements of a compound lens in a ‘telescopic’ fashion. As such, a compound lens can only be collapsed to a thickness which is the sum of all thicknesses of its constituent parts—and no less. Thus, a barrel lens still has significant thickness even in its collapsed or storage mode. This thickness generally is too large to be used in compact devices such as smartphones.

The current disclosure introduces a collapsible lens mounts to accommodate a plurality of lens elements from which a high performance compound lens may be formed. Rather than collapsing on axis, these specialized systems may collapse down into a very thin space or planar volume into which all the lens elements may be positioned in a storage mode. Since the thickness system in its storage mode is approximately only as thick as the thickest single element, a considerable advantage is realized. Compound lens systems of this nature may be integrated into very small packages—for example those associated with very portable systems such as a smartphone.

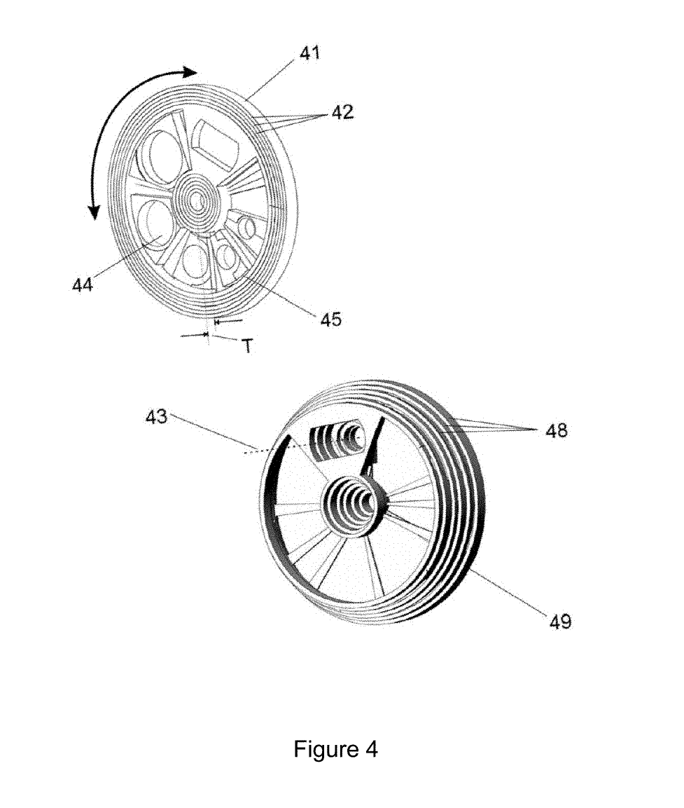

FIG. 4 illustrates the preferred embodiment of the disclosed collapsible imaging system 41 where a plurality of mechanically coupled disk shaped frames or substrates 42 may be counter rotated against each other to move a set of lens elements (e.g. lens singlets) from a thin planar volume storage mode into an imaging mode in which the lens elements are aligned on a single optic or imaging axis 43 forming an system having appreciable thickness.

In the preferred embodiment of the invention, the user can apply a tactile force to the outermost ring, in order to transition the system from aforementioned collapsed storage mode into an active imaging mode. By careful selection of lens singlets and prescribed spacing between these frames in their imaging mode, it is possible to realize preferred compound lenses such as the Cooke triplet arrangement shown in FIG. 1.

FIG. 4 illustrates example of five lens elements accommodated in lens receiving spaces of the disk-shaped frames to support an advanced compound lens system in the preferred embodiment of the invention. For the alternative embodiment, the two of such frames can be omitted, leaving enough space to support the three lenses such as the Cooke triplet. Another alternative arrangements having between two and six individual lens elements are possible.

In connection to FIG. 4, optical lenses are held in receiving cavities 44 or spaces of these frames. These lenses are capable operating together when correctly positioned to form a high performance compound lens, i.e. when the mount system is located in its imaging mode. When the mount system is returned to a storage mode, the system thickness ‘T’ is substantially reduced. To transition such system in between modes, the discs should be rotated (in the opposite direction), while the cam follower (i.e. track follower) with mechanical interlocks enable the disks to move and collapse into very thin flat volume.

In the preferred embodiment of the invention, the system has a translational motion (not necessary along the optical axis) with two endpoints or terminal ends. When fully translated in a first direction (expanded), the device is in an imaging mode with compound lens elements aligned along the optic axis. When fully translated (compressed) in an opposing direction to a second endpoint, the frames collapse into themselves, thereby moving the lens elements into a tight thin volume to form a storage mode.

Accordingly, a collapsible compound lens can be formed in this manner and may be integrated with imagers (optical sensors) with very limited space and strict weight limitations.

While some prior art telescopically collapsible barrel lens systems provide excellent portability for point and shoot camera systems, they remain far too thick and bulky in comparison with the disclosed system. The main distinctive feature of the preferred embodiment of the invention is that lens elements can be distributed off axis in a storage (i.e. collapsed). This allows a far thinner storage mode compare to the conventional telescopic systems.

Because the small thickness of a resting device in the storage mode (in some cases close to 10 millimeters, for example), the disclosed system becomes compact and well-suited for integration, providing a great imaging solution (i.e. for cell-phones, etc.).

While the rotating system illustrated in FIG. 4 is the preferred embodiment of the invention, it should be understood that several alternative mechanical arrangements with lens elements being translated from an imaging position into a compact storage position are possible.

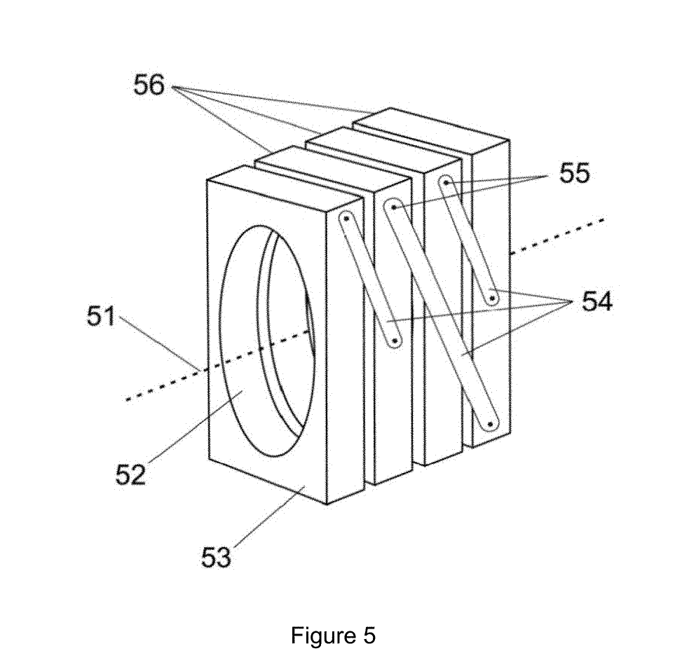

For example, one alternative embodiment of the invention includes a ‘flip’ system arrangement with lever arms and pivots. This arrangement may be characterized as a linear translation system, which moves all lens elements along a single line orthogonal to the imaging axis as illustrated in the FIG. 5.

An optical axis 51 of such linear ‘flip’ type system provides a structure upon which a compound lens of multiple lens elements may be arranged. With the reference to the FIG. 5, the lens receiving cavities 52 of the frame 53 are fashioned to receive and hold various optical lenses (not shown in the FIG. 5). Coupling levers 54 are coupled to these frames at the respective pivot points 55. Such arrangement enables translations of the compound lens elements (located at cavities 52) that may be characterized as collapsing from a stacked arrangement into a flattened layout where all frame elements 56 (with respective lenses) ultimately share a single flat space. Such linear ‘flip’ type system mechanical systems can be used in connection with an lens array system deployed with an image detector.

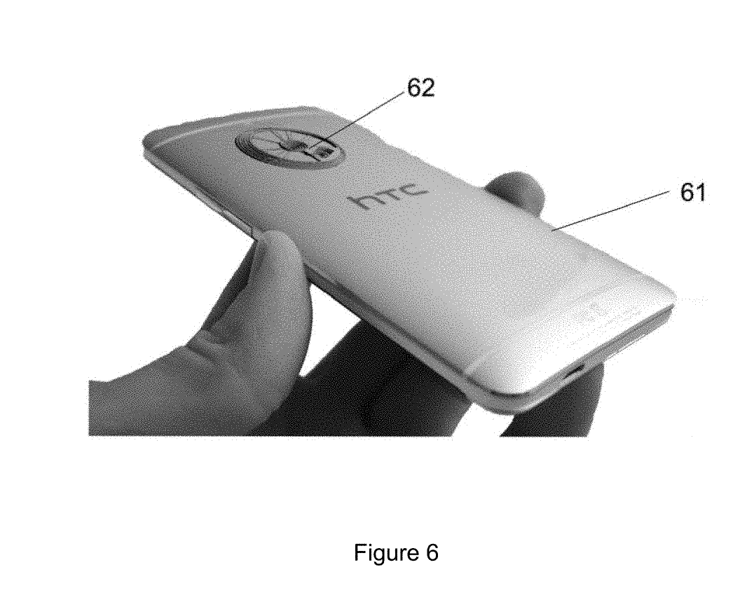

The advantages of system explained in FIG. 4 can be easily understood from the FIG. 6, where the integration into a case of a mobile smartphone housing is shown, as an example. As previously set forth in this disclosure, due to the space constrains of the mobile phone, a full integration with a barrel type telescoping compound lens would not be possible. Consequently, modern mobile smartphones, computers and tablets almost exclusively use very thin fixed lenses with a single lens element in most cases.

Accordingly, FIG. 6 illustrates the integration of the disclosed high performance collapsible compound lens system with a smartphone type camera device. With the reference to FIG. 6, a metallic smartphone case 61 is integrated with the collapsible lens system 62 in conjunction with the internal smartphone camera detector. This collapsible system 62 is well compatible with a smartphone type imager due to its thin configuration in a storage mode. For the imaging mode, the described (see FIG. 4 and FIG. 5) mechanism is used to extend (transition) the individual lens elements to form together a compound lens. During this transition, each of such lens element is aligned along a common system axis of imaging system. When the device is no longer being used for imaging, the compound lens is collapsed (transitioned in opposite direction) down, for example, via a simple tactile manipulation into a storage mode characterized by a thin flat space.

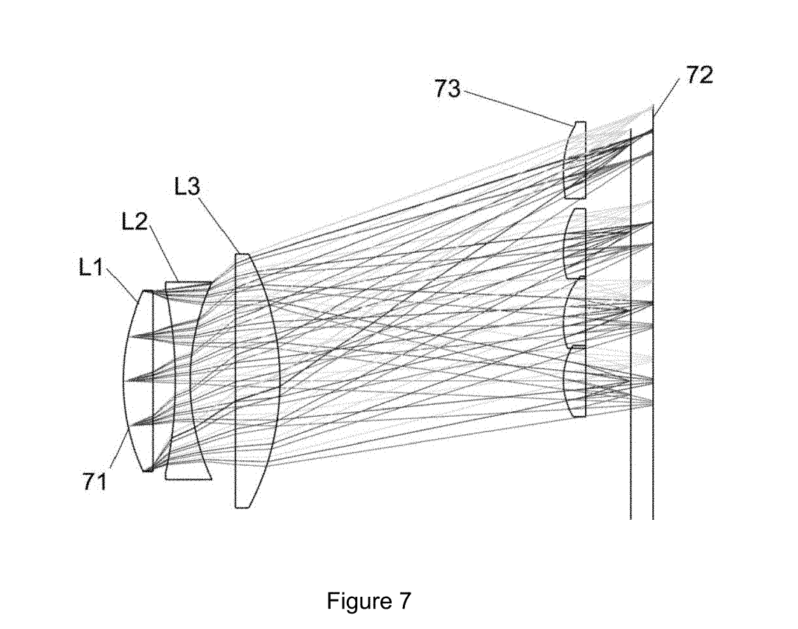

FIG. 7 illustrates a ray tracing diagram to better demonstrate a lens array in close proximity to image plane. Because (as described before) the power of each lens can be controlled separately (i.e. pre-designed), it is possible to apply correction to ray bundles (representing the optical wavefront) as a function of their distance from the optical axis. In this way, such pre-designed lens array provides correction for specific lens aberrations that associated with described compound lenses. In a preferred embodiment of the invention, the amount of the lens elements in the compound is less than six. Accordingly, in connection to the FIG. 7, a compound lens ‘collector’ part is comprised of optical elements L1, L2, and L3 that together form a compound imaging lens, such as a Cooke Triple configuration, for example. While such imagers have relatively good imaging characteristics, the remaining aberrations are still present at the image plane, particularly in portions of the image plane that are far from the axis. Rays propagating from a single point 71 have different paths through the optical system to be rejoined together at the image plane 72. Prior to being imaged, the wavefronts passes through the lenslets 73 of the lens array system. It should be noted, that ray bundles (parts of the optical wavefront) far from the axis would experience a higher focus power than those closer to the system axis (due to the predesigned lens array with the distributed lens power, as described above). Accordingly, the aberrations which generally have an increasing gradient value along the distance from the optical axis can be compensated by the specially pre-designed (i.e. having gradient lenslet power value increasing along the distance from the optical axis) lens arrays near the image plane.

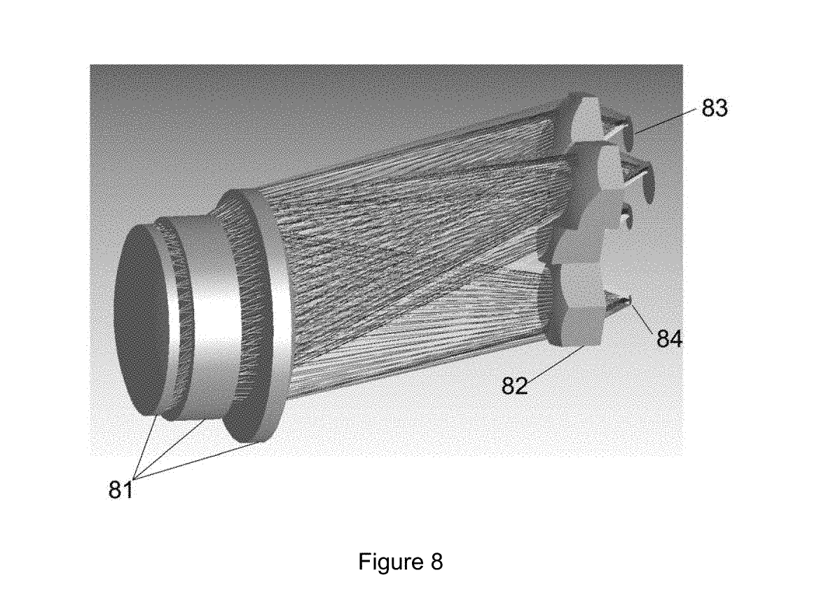

The preferred embodiment of the invention shown in FIG. 7 can be understood better with the reference to the FIG. 8 which illustrates a 3-dimensional model of the collector portion of the optical system (arranged as explained in the FIG. 7) having three lens elements 81, a lens array made of a plurality of hexagonal lenslets 82, served to compensate for image aberrations at the image plane. With the reference to the FIG. 8, it can be seen that the ray bundles that are far from the imaging axis (marked 83 on the FIG. 8) have a different focusing power compare to the ray bundles that are closer to the axis, (marked 84 in the FIG. 8). This is achieved due to the pre-designed variances of the refractive surfaces (e.g. curvature, size, refractive index) of each lenslet device within the array.

In the alternative embodiment of the invention, the lenslet devices may not in fact be axially symmetric. Since lenslets within array are not used for conventional imaging, they can be formed without axial symmetry, unlike to typical imaging lens. For example, some lithographic process techniques allow modification shape and size of the lenslets during manufacturing, including asymmetric lenslet designs.

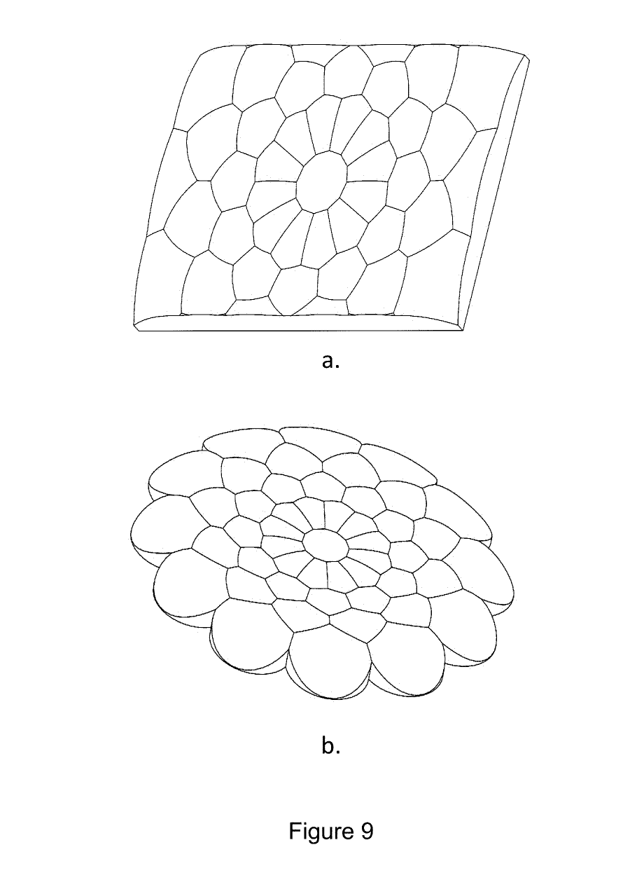

The lenslets within the lenslet array can have a polygon or, in general, arbitrary shape. FIGS. 9a and 9b illustrate the example of lenslet arrays where each lenslet has a polygon shape (with generally arbitrary surface shape and arbitrary shape of edges) and variable focusing power. The surfaces of the neighboring lenslets are smoothly connected without abrupt edges. The focusing power of the lenslets within the lenslet array can have a larger value at the center of the lenslet array. The surface area of each lenslet within the array can also vary. In the preferred embodiment of the invention, the surface area of each lenslets being in order of about 0.5-5 square millimeters and/or aperture of not more than 1 square millimeter.

In a more general embodiment of the invention, the surface area of each lenslets has different refractive, diffractive characteristic or its (refractive and diffractive) combination. In an alternative embodiment of the invention, the lenslet array can be compound, i.e. composed of a multiple number of smaller lenslet arrays.

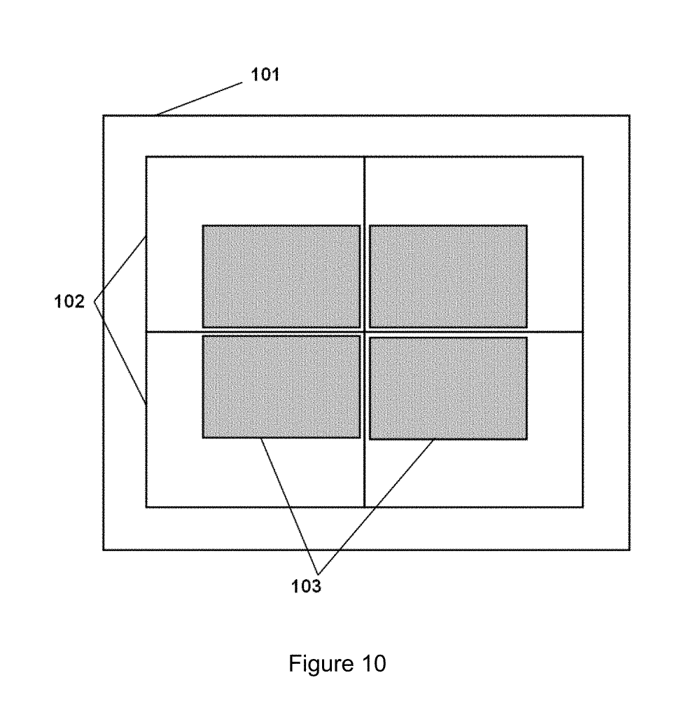

The imaging detector (image sensor) can also be composed of multiple detectors (i.e. any number of smaller single imaging sensors). FIG. 10 illustrates the example of such compound image detector (sensor) configuration 101 (top view) comprised of four (as an example) separate single sensor packages 102, each of them, in turn, having a single sensor area 103. It is evident (also from FIG. 10), that such compound sensor configuration has so-called ‘dead zones’ located along the adjacent boundaries of single sensing elements 103.

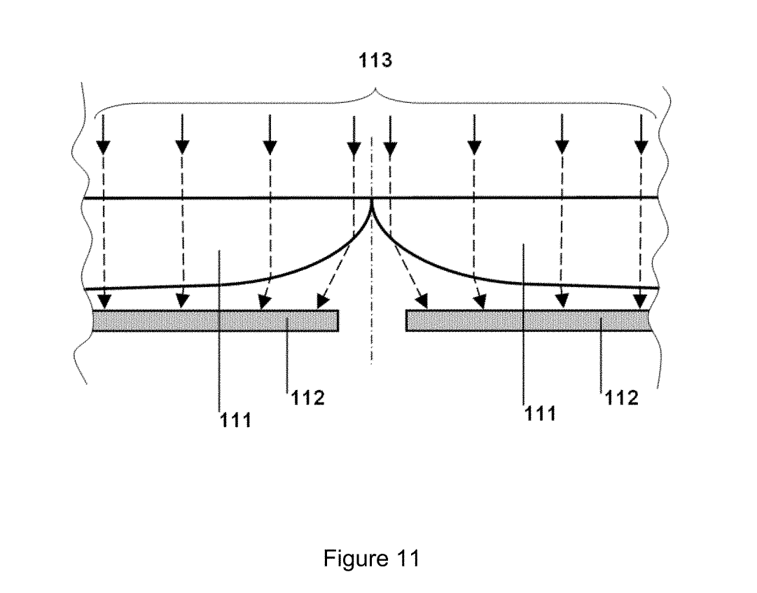

In conventional imaging systems, such ‘dead zones’ will be translated into the missing imaging data (missing pixels) of the image detected by the optical system. In one embodiment of the disclosed invention, however, such ‘dead zones’ can be effectively eliminated by using a respective lenslet configurations within the lenslet array, as is schematically shown in FIG. 11.

FIG. 11 illustrates the particular configuration of the adjacent lenslet 111 (within the lenslet array) that effectively steer the optical wavefront (optical rays) 113 from the mentioned ‘dead zones’ located in between (along the boundaries) of the adjacent sensing elements 112. As can be seen from the FIG. 11 (cross-section view), the focusing power of each adjacent lenslet 111 has a gradual distribution designed in such a way that the incident optical rays aimed at the ‘dead zone’ (i.e. falling between the adjacent sensing elements 112) are steered away of the ‘dead zone,’ towards the operational part of the sensing elements 112. By these means, the disclosed invention provides an efficient way of implementing multiple smaller (and cost effective) sensor matrices for high-resolution optical system. Such feature can be (optionally) combined with the collapsible capability of the optical system, which is explained in details above.

In addition to using special purpose lens arrays at (or near) the image plane for the purpose of correcting lens aberrations, it is also possible to further improve the image quality by making adjustments in a digital domain. Each element of the imaging system affects the incident wavefront having its own impulse response function that can be measured in advance for a particular imaging system. Accordingly, a post processing or digital filter can be used to further improve the image quality and/or reduce the price of the imaging system.

For example, an artificial neural-network (ANN) type self-learning algorithm can be used to adjust the algorithm parameters based on the feedback obtained from the digital signal at the image plane. By these means, a custom ‘digital filter’ can be derived that is matched to the optical system, including the collector portion and the lens array portion—i.e. the non-digital portion of the device, as shown, for example in the FIG. 7 and FIG. 8.

The combination of the (predesigned) lens array and the derived digital filter can be used to achieve even better image quality. It should be noted that such disclosed method does not require any special modification of the collector optics (e.g. aforementioned triplet), and relatively basic collector designs can still be used in the described embodiment of the invention, providing a highest image quality.

The disclosed invention provides an effective aberration reduction means in a form of and very compact collapsible system (with optionally compound image sensor). As explained above, in the conventional collapsible lens systems, the lens elements collapse along the optic axial in a telescopic translation with minor or negligible off-axis lens placement errors. For the rotating or folding arrangement described herein, however, the lens placement errors are more complex, requiring the non-conventional approach as disclosed. As such, it is particularly beneficial to collapsible lens systems (such as those proposed herein) to deploy a lens array near the image plane, optionally in combination with the disclosed digital filtering technique applied in a digital domain.

To summarize, the proposed versions of the invention include a collapsible lens system having two modes: a storage mode and an imaging mode, where the storage mode characterized as having a plurality of lens elements that are packed in a thin compact volume. Further, the invention includes aberration mitigation means comprising of a lens array positioned near the image plane (i.e. image sensor).

The sensor imaging area can be built of smaller sensors, where the boundary ‘dead zones’ are being eliminated by the lenslet design, as explained above. Furthermore, the invention optionally includes a digital filtering aberration correction method of digital (algorithmic) correction that is adjusted (predesigned) to the precise nature of the optical system (e.g. combination of optical elements of the compound lens).

The invention is not limited to the preferred embodiment described above. The described embodiments illustrate preferred versions of the devices and methods of the invention. Therefore, there other embodiments may exist within the spirit and scope of this disclosure as set forth by appended claims, but do not appear here as specific examples. Although the present invention was described in considerable details, other modifications of the preferred embodiments would be obvious to the person skilled in the art. Therefore, the spirit and scope of the invention should not be limited by the description of the preferred versions contained therein, but rather by the claims appended hereto.

What claimed is:

1. A collapsible imaging system comprising:
a plurality of lens elements, an optical axis, an optical image sensor and a lenslet array;
wherein the lenslet array formed of multiple single lenslets, and the lenslet array positioned in a proximity to the optical image sensor, and wherein the collapsible imaging system having an imaging mode and a storage mode, wherein the imaging mode has the plurality of lens elements arranged along the optical axis, and the storage mode has the plurality of lens elements arranged within a flat volume.

2. The collapsible imaging system of claim 1, wherein the plurality of lens elements is transitioned between the imaging mode and the storage mode using translation or rotation movements, the movements performed along the optical axis or off the optical axis.

3. The collapsible imaging system of claim 1, wherein a focusing power of the lenslets within the lenslet array is different from each other.

4. The collapsible imaging system of claim 3, wherein the focusing power of each of the lenslet within the lenslet array is a function of the distance from this lenslet to a center of the lenslet array, wherein the center of the lenslet array is a crossing of the optical axis and the lenslet array.

5. The collapsible imaging system of claim 4, wherein the function is characterized by a gradient change of the focusing power, wherein the focusing power has a larger value at the center of the lenslet array.

6. The collapsible imaging system of claim 1, wherein the each lenslet has an arbitrary surface shape and an arbitrary shape of edges.

7. The collapsible imaging system of claim 1, wherein the surface area of each lenslets has refractive, diffractive or both refractive and diffractive properties.

8. The collapsible imaging system of claim 1, wherein the surface area of each lenslets being in order of about 0.5-5 square millimeters.

9. The collapsible imaging system of claim 1, wherein the lenslets within the lenslet array having an aperture of not more than 1 square millimeter.

10. The collapsible imaging system of claim 1, wherein surfaces of the neighboring lenslets are smoothly connected without abrupt edges.

11. The collapsible imaging system of claim 1, wherein the lenslet array is composed of a multiple number of smaller lenslet arrays.

12. The collapsible imaging system of claim 1, wherein the image sensor is composed of a multiple number of smaller image sensors, the smaller image sensors having adjacent boundaries between each other.

13. The collapsible imaging system of claim 12, wherein the lenslets having the gradient change of the focusing power to steer the incident light out of the adjacent boundaries between the smaller image sensors.

14. The collapsible imaging system of claim 1, further comprising a digital filter, wherein the digital filter being predesigned for the imaging system in order to compensate for specific aberrations caused by the imaging system.

15. The collapsible imaging system of claim 14, wherein the digital filter uses an artificial neural network.

16. The collapsible imaging system of claim 1, wherein the plurality of lens elements form a Cooke triplet.

17. A chromatic aberration correction method of executing a correction of chromatic aberration for an image, comprising operating a collapsible imaging system, wherein the collapsible imaging system comprising:
a plurality of lens elements, an optical axis, an optical image sensor and a lenslet array; wherein the lenslet array formed of multiple single lenslets, and the lenslet array positioned in a proximity to the optical image sensor, and
wherein the collapsible imaging system having an imaging mode and a storage mode, wherein the imaging mode has the plurality of lens elements arranged along the optical axis, and the storage mode has the plurality of lens elements arranged within a flat volume.

18. The chromatic aberration correction method of claim 17, wherein the plurality of lens elements of the collapsible imaging system is transitioned between the imaging mode and the storage mode using translation or rotation movements, and the movements performed along the optical axis or off the optical axis.

19. The chromatic aberration correction method of claim 17, wherein the collapsible imaging system has a focusing power of the lenslets within the said lenslet array is different from each other.

20. The chromatic aberration correction method of claim 17, wherein the collapsible imaging system has the focusing power of the each lenslet within the lenslet array is a function of the distance from this lenslet to a center of this lenslet array, and wherein the center of the lenslet array is a crossing of the said optical axis and the lenslet array.
